(19) United States
(12) Patent Application Publication
(10) Pub. No.: US 2023/0331000 A1
(43) Pub. Date: Oct. 19, 2023

(54) PRINTING METHOD, PRINTING APPARATUS, AND PRINTED MATTER

(71) Applicants: Sei Yamamoto, Tokyo (JP); Tomohiro Nakagawa, Kanagawa (JP); Kazuhiko Umemura, Shizuoka (JP); Yuya Hirokawa, Kanagawa (JP); Hiroki Hagiwara, Kanagawa (JP); Takuya Saiga, Kanagawa (JP)

(72) Inventors: Sei Yamamoto, Tokyo (JP); Tomohiro Nakagawa, Kanagawa (JP); Kazuhiko Umemura, Shizuoka (JP); Yuya Hirokawa, Kanagawa (JP); Hiroki Hagiwara, Kanagawa (JP); Takuya Saiga, Kanagawa (JP)

(73) Assignee: Ricoh Company, Ltd., Tokyo (JP)

(21) Appl. No.: 18/005,041

(22) PCT Filed: Aug. 20, 2021
(86) PCT No.: PCT/IB2021/057662

§ 371 Date: Jan. 10, 2023

(30) Foreign Application Priority Data
Sep. 16, 2020 (JP) 2020-155061
Jun. 15, 2021 (JP) 2021-099313

(51) Int. Cl. B41J 2/21; B41J 11/00; B41M 5/50

(52) U.S. Cl. CPC B41J 2/2117; B41J 11/002; B41M 5/50

(57) ABSTRACT

A printing method involves applying a processing fluid containing a multivalent metal salt to a print medium, to form a processing fluid layer; applying a white ink containing a white coloring material and water to form a white ink layer; and applying a non-white ink containing a non-white coloring material and water to the white ink layer, after securing a time interval of 0.5 seconds or longer after the white ink is applied without drying with a drying unit after the white ink is applied. The print medium has a Cobb water absorption of 20 g/m² or greater but 75 g/m² or less when contacted with water for 120 seconds, where the Cobb water absorption is stipulated by JIS-P8140.

### TECHNICAL FIELD

The present disclosure relates to a printing method, a printing apparatus, and a printed matter.

### BACKGROUND ART

In recent years, techniques for inkjet printers have been being developed not only for home use, but also for inkjet image formation over packaging materials for, for example, foods, beverages, and daily necessities. Examples of the print media in the packaging use include cardboard.

The methods for cardboard printing are roughly classified into the method of recording an image over the cardboard base paper (front liner paper) with print inks and then pasting the base paper with a corrugating medium and back liner paper using a corrugator to produce a piece of cardboard (pre-printing method), and the method of recording an image over the front liner paper of an already pasted piece of cardboard with print inks (post-printing method).

For example, offset printing, flexography, and gravure printing have been hitherto used for cardboard printing. All of these methods print images over print media by bringing plates or blankets into contact with the print media and transferring inks onto the print media under printing pressures. Therefore, the post-printing method tends to generate density unevenness due to the influence of the bosses and recesses (flute corrugations) of the surface of the cardboard. Particularly, post-printing over thick cardboard has been difficult. On the other hand, the pre-printing method can overcome the printing-related problem, but has a problem that it takes a long time for the pasting step after the printing and cannot move to the box making step immediately after the printing.

The inkjet printing is a method of recording images over print media in a contactless manner. Therefore, the inkjet printing can easily post-print images over thick cardboard, move to the box making step immediately after the printing, and meet short delivery deadlines. Hence, the cardboard printing has an increasing demand for the inkjet printing.

For color printing over cardboard base paper, white cardboard base paper is widely used. This is because a good color developability cannot be obtained when color inks (hereinafter, may be referred to as “non-white inks”) are directly printed over brown cardboard base paper. Meanwhile, although not widely spread, a proposed printing method prints a white ink over brown cardboard base paper and successively applies non-white inks over the white ink. However, printing methods using water-based inks have quality problems such as bleed, density degradation, and cissing of non-white inks, and cannot sufficiently satisfy consumers' quality requirements such as high density and high resolution.

Hence, a proposed method uses a fluorescent ink and a non-white ink in combination to improve color developability and color reproducibility (for example, see PTL 1). Another proposed method prints a non-white ink over a white ink with a good color developability (for example, see PTL 2).

### CITATION LIST

### Patent Literature

[PTL 1]
Japanese Patent No. 6140908
[PTL 2]
Japanese Unexamined Patent Application Publication No. 2014-83789

### SUMMARY OF INVENTION

### Technical Problem

The present disclosure has an object to provide a printing method of printing a white ink over cardboard base paper having a high coefficient of water absorption and applying a non-white ink over the white ink. The printing method can prevent bleed, density degradation, and cissing of the non-white ink and realize an excellent image quality.

### Solution to Problem

According to an embodiment of the present disclosure, a printing method includes a processing fluid applying step of applying a processing fluid containing a multivalent metal salt to a print medium, a white ink applying step of applying a white ink containing a white coloring material and water to form a white ink layer, and a non-white ink applying step of applying a non-white ink containing a non-white coloring material and water to the white ink layer after securing a time interval of 0.5 seconds or longer after the white ink is applied without providing a drying step of performing drying with a drying unit after the white ink is applied. The print medium has a Cobb water absorption of 20 g/m² or greater but 75 g/m² or less when contacted with water for 120 seconds, where the Cobb water absorption is stipulated by Japanese Industrial Standards (JIS)-P8140.

### Advantageous Effects of Invention

The present disclosure can provide a printing method of printing a white ink over cardboard base paper having a high coefficient of water absorption and applying a non-white ink over the white ink. The printing method can prevent bleed, density degradation, and cissing of the non-white ink and realize an excellent image quality.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a schematic view illustrating a method for printing over cardboard by a pre-printing method.

FIG. 2 is a schematic view illustrating a method for printing over cardboard by a post-printing method.

FIG. 3 is a schematic view illustrating a printing apparatus according to an embodiment of the present disclosure, used in a printing method according to an embodiment of the present disclosure.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

(Printing Method and Printing Apparatus)

A printing method of the present disclosure includes a processing fluid applying step of applying a processing fluid containing a multivalent metal salt to a print medium, a white ink applying step of applying a white ink containing a white coloring material and water to form a white ink layer, and a non-white ink applying step of applying a non-white ink containing a non-white coloring material and water to the white ink layer after securing a time interval of 0.5 seconds or longer after the white ink is applied without providing a drying step of performing drying with a drying unit after the white ink is applied, wherein the print medium has a Cobb water absorption of 20 g/m² or greater but 75 g/m² or less when contacted with water for 120 seconds, where the Cobb water absorption is stipulated by JIS-P8140. The printing method preferably includes a drying step, and further includes other steps as needed.

A printing apparatus of the present disclosure includes a processing fluid applying unit configured to apply a processing fluid containing a multivalent metal salt to a print medium, a white ink applying unit configured to apply a white ink containing a white coloring material and water to form a white ink layer, and a non-white ink applying unit configured to apply a non-white ink containing a non-white coloring material and water to the white ink layer after securing a time interval of 0.5 seconds or longer after the white ink is applied without providing a drying step of performing drying with a drying unit after the white ink is applied, wherein the print medium has a Cobb water absorption of 20 g/m² or greater but 75 g/m² or less when contacted with water for 120 seconds, where the Cobb water absorption is stipulated by JIS-P8140. The printing apparatus preferably includes a drying unit and further includes other units as needed.

The printing method of the present disclosure can be suitably performed by the printing apparatus of the present disclosure. The processing fluid applying step can be performed by the processing fluid applying unit. The white ink applying step can be performed by the white ink applying unit. The non-white ink applying step can be performed by the non-white ink applying unit. The drying step can be performed by the drying unit. The other steps can be performed by the other units.

The existing technique described in PTL 1 has difficulty overcoming the influence of cardboard base paper on color developability of a non-white ink, and fluorescent substances have a poor chemical resistance and a poor weather resistance. Hence, this technique does not have a sufficient versatility.

The existing technique described in PTL 2 uses a first flocculant reactive with white particles contained in a white ink and a second flocculant reactive with a dye contained in a color ink in an upper layer and a lower layer of a white ink. The technique needs to supply the flocculants a plurality of times to a print medium. Hence, there is a problem that the technique does not have a sufficient versatility.

The present disclosure can obtain a high-quality printed matter with little bleed, degraded density, and cissing by including a processing fluid applying step of applying a processing fluid containing a multivalent metal salt to a print medium, a white ink applying step of applying a white ink containing a white coloring material and water to form a white ink layer, and a non-white ink applying step of applying a non-white ink containing a non-white coloring material and water to the white ink layer after securing a time interval of 0.5 seconds or longer after the white ink is applied without providing a drying step of performing drying with a drying unit after the white ink is applied, wherein the print medium has a Cobb water absorption of 20 g/m² or greater but 75 g/m² or less when contacted with water for 120 seconds, where the Cobb water absorption is stipulated by JIS-P8140. That is, applying a non-white ink over the white ink layer after securing a time interval of 0.5 seconds or longer after the white ink is applied without providing a drying step of performing drying with a drying unit after the white ink is applied can secure a time needed for the multivalent metal salt contained in the processing fluid to serve as a flocculant and react with the white coloring material contained in the white ink, and can prevent bleed (color bleed) and density degradation due to mixed presence of the non-white ink and the white ink. Moreover, skipping drying the white ink layer can prevent the white ink from drying and forming a film, and can keep any unreacted multivalent metal salt, which is diffused in the white ink, mobile and reactive with the coloring material contained in the non-white ink and prevent cissing of the non-white ink.

<Processing Fluid Applying Step and Processing Fluid Applying Unit>

The processing fluid applying step is a step of applying a processing fluid containing a multivalent metal salt to a print medium having a Cobb water absorption of 20 g/m² or greater but 75 g/m² or less when contacted with water for 120 seconds, where the Cobb water absorption is stipulated by JIS-P8140. The processing fluid applying step is performed by the processing fluid applying unit.

<<Processing Fluid>>

The processing fluid is applied to a print medium before a white ink is applied to the print medium. The processing fluid may be referred to as “pre-processing fluid” or “precoat fluid”.

The processing fluid contains a multivalent metal salt, and further contains other components as needed.

The viscosity of the processing fluid at 25 degrees C. may be adjusted in a range of 5 mPa-s or higher but 1,000 mPa-s or lower depending on the applying manner. This viscosity can be measured with, for example, a rotary viscometer (available from Toki Sangyo Co., Ltd., RE-80L). As the measuring conditions, the viscosity can be measured at 25 degrees C. with a standard cone rotor (1° 34′×R24) with a sample liquid amount of 1.2 mL at a number of rotations of 50 rpm for three minutes. It is preferable that the viscosity of the processing fluid at 25 degrees C. be 5 mPa-s or higher but 50 mPa-s or lower, because the processing fluid can be applied to a print medium more uniformly, and as a result, an ink can be applied to the print medium more uniformly and can form an image without unevenness.

The method for applying the processing fluid is not particularly limited and may be appropriately selected depending on the intended purpose. Examples of the method include, but are not limited to, an inkjet method, a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a four-roll coating method, a five-roll coating method, a dip coating method, a curtain coating method, a slide coating method, and a die coating method. The applying method can be appropriately selected depending on, for example, the material and the thickness of the print medium.

The amount of the processing fluid to be applied to a print medium, expressed as the amount of a solid component applied, is preferably 2 g/m² or greater but 30 g/m² or less and more preferably 5 g/m² or greater but 20 g/m² or less.

After the processing fluid is applied to a print medium, it is optional to dry the processing fluid layer. However, it is preferable to apply the white ink over the processing fluid layer without drying the processing fluid layer, in terms of space saving and energy saving. It is preferable to apply the white ink within five seconds after the processing fluid is applied to a print medium.

Multivalent Metal Salt

The multivalent metal salt has a function of making dispersion of a white coloring material contained in the white ink unstable, and can speedily coagulate the white coloring material contained in the white ink after a droplet of the white ink lands, and prevent bleed (color bleed) and density degradation due to mixed presence of a non-white ink and a white ink.

The cation of the multivalent metal salt is not particularly limited and may be appropriately selected depending on the intended purpose. Examples of the cation of the multivalent metal salt include, but are not limited to, the ions of aluminum (Al(III)), calcium (Ca(II)), magnesium (Mg(II)), copper (Cu(II)), iron (Fe(II) or Fe(III)), zinc (Zn(II)), tin (Sn(II) or Sn(IV)), strontium (Sr(II)), nickel (Ni(II)), cobalt (Co(II)), barium (Ba(II)), lead (Pb(II)), zirconium (Zr(IV)), titanium (Ti(IV)), antimony (Sb(III)), bismuth (Bi(III)), tantalum (Ta(V)), arsenic (As(III)), cerium (Ce(III)), lanthanum (La(III)), yttrium (Y(III)), mercury (Hg(II)), and beryllium (Be(II)). One of these cations may be used alone or two or more of these cations may be used in combination. Among these cations, the cations of calcium (Ca(II)) and magnesium (Mg(II)) are preferable.

The anion of the multivalent metal salt is not particularly limited and may be appropriately selected depending on the intended purpose. Examples of the anion of the multivalent metal salt include, but are not limited to, the ions of halogen elements such as fluorine (F), chlorine (Cl), bromine (Br), and iodine (I); nitrate ion (NO₃⁻) and sulfate ion (SO₄²⁻); the ions of organic carboxylic acids such as formic acid, acetic acid, lactic acid, malonic acid, oxalic acid, maleic acid, and benzoic acid; the ions of organic sulfonic acids such as benzene sulfonic acid, naphthol sulfonic acid, and alkylbenzene sulfonic acid; and thiocyanate ion (SCN, thiosulfate ion S₂O₃²⁻), phosphate ion (PO₄³⁻), and nitrite ion (NO²⁻). One of these anions may be used alone or two or more of these anions may be used in combination. Among these anions, chloride ion (Cl⁻), sulfate ion (SO₄²⁻), and nitrate ion (NO₃⁻) are preferable in terms of costs and safety.

The multivalent metal salt is not particularly limited and may be appropriately selected depending on the intended purpose. Examples of the multivalent metal salt include, but are not limited to, aluminum chloride, calcium chloride, nickel chloride, potassium acetate, sodium acetate, calcium acetate, magnesium acetate, aluminum nitrate, magnesium nitrate, magnesium chloride, calcium nitrate, magnesium hydroxide, aluminum sulfate, magnesium sulfate, and ammonium alum. More specific examples of the multivalent metal salt include, but are not limited to, calcium acetate monohydrate, calcium nitrate tetrahydrate, calcium chloride hexahydrate, magnesium acetate tetrahydrate, magnesium sulfate (anhydrous), aluminum nitrate nonahydrate, and nickel chloride hexahydrate. One of these multivalent metal salts may be used alone or two or more of these multivalent metal salts may be used in combination. Among these multivalent metal salts, calcium acetate monohydrate, calcium nitrate tetrahydrate, calcium chloride hexahydrate, magnesium acetate tetrahydrate, and magnesium sulfate (anhydrous) are preferable.

The proportion of the multivalent metal salt is preferably 7% by mass or greater, more preferably 12% by mass or greater, and yet more preferably 12% by mass or greater but 25% by mass or less relative to the total amount of the processing fluid. The proportion of the multivalent metal salt is preferably 7% by mass or greater because bleed of a non-white ink over a white ink can be suppressed. The proportion of the multivalent metal salt is preferably 25% by mass or less because the multivalent metal salt has a high stability during a long-term storage of the processing fluid and can be suppressed from quality defects such as precipitation.

Other Components

Examples of the other components include, but are not limited to, a resin, an organic solvent, water, a surfactant, a defoaming agent, a preservative and a fungicide, a corrosion inhibitor, and a pH regulator.

Resin

The processing fluid may contain a resin. The kind of the resin is not particularly limited and any resin can be used. However, at least one selected from acrylic resins, polyolefin resins, polyvinyl acetate resins, polyvinyl chloride resins, urethane resins, and copolymers of these resins is preferable because a strong adhesiveness with various kinds of print media can be obtained.

When adding the resin in the processing fluid, it is possible to add the resin in the form of a liquid obtained by dispersing resin particles in water. It is also possible to use a resin commercially available as a resin emulsion.

The volume average particle diameter of the resin particles is not particularly limited, may be appropriately selected depending on the intended purpose, and is preferably 10 nm or greater but 1,000 nm or less, more preferably 10 nm or greater but 200 nm or less, and particularly preferably 10 nm or greater but 100 nm or less in terms of obtaining a suitable dispersibility, fixability, and a high image hardness.

The volume average particle diameter can be measured with, for example, a particle size analyzer (NANOTRAC WAVE-UT151, available from MicrotracBEL Corp).

Considering compatibility and stability when the resin is mixed with the multivalent metal salt, the acid value of the resin is preferably 20 mgKOH/g or less.

The resin may have any glass transition temperature (Tg) so long as the resin can maintain adhesiveness with a print medium and a drying property. For example, a resin having a glass transition temperature in the range of −25 degrees C. or higher but 70 degrees C. or lower can be suitably used. The glass transition temperature (Tg) of the resin is preferably −25 degrees C. or higher in terms of suppressing stickiness of the surface of a print medium and blocking between overlaid print media. The glass transition temperature (Tg) of the resin is preferably 70 degrees C. or lower in order to maintain adhesiveness of the resin and avoid cracking or peeling during a bending process in the box making step. Particularly when cardboard is used as a print medium, desirable effects can be obtained.

The proportion of the resin is preferably 30% by mass or less and more preferably 0.5% by mass or greater but 20% by mass or less relative to the total amount of the processing fluid. The proportion means the mass percentage of a resin solid component contained in the processing fluid. The proportion of the resin of 30% by mass or less is preferable because the resin can be prevented from growing extremely thick after the processing fluid is applied, making it possible to suppress occurrence of blocking and changes of the appearance of cardboard and to make the multivalent metal salt work sufficiently effectively.

Organic Solvent

There is no specific limitation on the type of the organic solvent used in the present disclosure. For example, water-soluble organic solvents are suitable. Specific examples thereof include, but are not limited to, polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrolidone, N-methyl-2-pyrolidone, N-hydroxyethyl-2-pyrolidone, 1,3-dimethyl-2-imidazolidinone, ε-caprolactam, and 7-butyrolactone; amides such as formamide, N-methylformamide, N,N-dimethylformamide, 3-methoxy-N,N-dimethyl propionamide, and 3-butoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

Since the water-soluble organic solvent serves as a humectant and also imparts a good drying property, it is preferable to use an organic solvent having a boiling point of 250 degrees C. or lower.

The proportion of the organic solvent in the processing fluid is not particularly limited, may be appropriately selected depending on the intended purpose, and is preferably 5% by mass or greater but 90% by mass or less and more preferably 10% by mass or greater but 70% by mass or less, considering, for example, the aptitude for application to a print medium, uniform dispersibility, and a drying property.

Water

The water is not particularly limited and may be appropriately selected depending on the intended purpose. Examples of the water include, but are not limited to, pure water such as ion-exchanged water, ultrafiltrated water, reverse osmotic water, and distilled water, and ultrapure water. One of these kinds of water may be used alone or two or more of these kinds of water may be used in combination. The content of the water in the processing fluid is not particularly limited, and the water needs at least to be contained in an amount enough for the multivalent metal salt not to precipitate during storage at normal temperature.

Surfactant

The surfactant has an effect of reducing the surface tension of the processing fluid and improving the wettability of the processing fluid on various kinds of print media, to enable the processing fluid to be applied uniformly and enable the multivalent metal salt contained in the processing fluid to be distributed uniformly over the print media.

Examples of the surfactant are silicone-based surfactants, fluorosurfactants, amphoteric surfactants, nonionic surfactants, anionic surfactants, etc.

The silicone-based surfactant has no specific limit and can be suitably selected to suit to a particular application. Of these, preferred are silicone-based surfactants which are not decomposed even in a high pH environment. Specific examples thereof include, but are not limited to, side-chain-modified polydimethylsiloxane, both end-modified polydimethylsiloxane, one-end-modified polydimethylsiloxane, and side-chain-both-end-modified polydimethylsiloxane. A silicone-based surfactant having a polyoxyethylene group or a polyoxyethylene polyoxypropylene group as a modifying group is particularly preferable because such an agent demonstrates good characteristics as an aqueous surfactant. It is possible to use a polyether-modified silicone-based surfactant as the silicone-based surfactant. A specific example thereof is a compound in which a polyalkylene oxide structure is introduced into the side chain of the Si site of dimethyl siloxane.

Specific examples of the fluoro surfactants include, but are not limited to, perfluoroalkyl sulfonic acid compounds, perfluoroalkyl carboxylic acid compounds, perfluoroalkyl phosphoric acid ester compounds, adducts of perfluoroalkyl ethylene oxide, and polyoxyalkylene ether polymer compounds having a perfluoroalkyl ether group in its side chain. These are particularly preferable because they do not foam easily. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carboxylic acid compounds include, but are not limited to, perfluoroalkyl carboxylic acid and salts of perfluoroalkyl carboxylic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain and salts of polyoxyalkylene ether polymers having a perfluoroalkyl ether group in its side chain. Counter ions of salts in these fluorine-based surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxy ethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides, etc.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactants have no particular limit and can be suitably selected to suit to a particular application. Specific examples thereof include, but are not limited to, side-chain-modified polydimethyl siloxane, both end-modified polydimethylsiloxane, one-end-modified polydimethylsiloxane, and side-chain-both-end-modified polydimethylsiloxane. In particular, a polyether-modified silicone-based surfactant having a polyoxyethylene group or a polyoxyethylene polyoxypropylene group as a modifying group is particularly preferable because such a surfactant demonstrates good characteristics as an aqueous surfactant. Any suitably synthesized surfactant and any product thereof available on the market is suitable. Products available on the market are obtained from Byk Chemie Japan Co., Ltd., Shin-Etsu Chemical Co., Ltd., Dow Corning Toray Silicone Co., Ltd., NIHON EMULSION Co., Ltd., Kyoeisha Chemical Co., Ltd., etc.

The polyether-modified silicone-containing surfactant has no particular limit and can be suitably selected to suit to a particular application. Examples thereof include, but are not limited to, a compound in which the polyalkylene oxide structure represented by the following General formula S-1 is introduced into the side chain of the Si site of dimethyl polysiloxane.

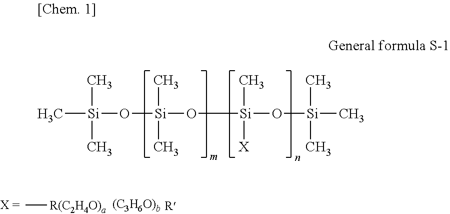

In the General formula S-1, “m”, “n”, “a”, and “b” each, respectively represent integers, R represents an alkylene group, and R′ represents an alkyl group.

Products available on the market may be used as the polyether-modified silicone-based surfactants. Specific examples of polyether-modified silicone-based surfactants include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Silicone Co., Ltd.), BYK-33 and BYK-387 (both manufactured by Byk Chemie Japan Co., Ltd.), and TSF4440, TSF4452, and TSF4453 (all manufactured by Toshiba Silicone Co., Ltd.).

A fluorosurfactant in which the number of carbon atoms replaced with fluorine atoms is from 2 to 16 and more preferably from 4 through 16 is preferable.

Specific examples of the fluorosurfactants include, but are not limited to, perfluoroalkyl phosphoric acid ester compounds, adducts of perfluoroalkyl ethylene oxide, and polyoxyalkylene ether polymer compounds having a perfluoroalkyl ether group in its side chain.

Of these, polyoxyalkylene ether polymer compounds having a perfluoroalkyl ether group in its side chain are preferable because they do not foam easily and the fluorosurfactant represented by the following General formula F-1 or General formula F-2 is more preferable.

[Chem. 2]

CF₃CF₂(CF₂CF₂)ₘ—CH₂CH₂O(CH₂CH₂O)ₙH General formula F-1

In General formula F-1, “m” is preferably 0 or an integer of from 1 to 10 and “n” is preferably 0 or an integer of from 1 to 40 in order to provide water solubility.

CₙF₂ₙ₊—CH₂CH(OH)CH₂—O—(CH₂CH₂O)ₐ—Y General formula F-2

In General formula F-2, Y represents H, CₘF₂ₘ₊₁, where “m” is an integer of from 1 to 6, CH₂CH(OH)CH₂-CₘF₂ₘ₊₁, where m represents an integer of from 4 to 6, or CₚH₂ₚ₊₁, where p represents an integer of from 1 to 19. “n” represents an integer of from 1 to 6. “a” represents an integer of from 4 to 14.

Products available on the market may be used as the fluorosurfactant. Specific examples of the products available on the market include, but are not limited to, SURFLON S-111, SURFLON S-112, SURFLON S-113, SURFLON S-121, SURFLON S-131, SURFLON S-132, SURFLON S-141, and SURFLON S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFAC F-470, F-1405, and F-474 (all manufactured by DIC CORPORATION); ZONYL (trademark) TBS, FSP, FSA, FSN-100, FSN, FSO-100, FSO, FS-300, UR, CAPSTONE (registered trademark) FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.), and UNIDYNE DSN-403N (manufactured by DAIKIN INDUSTRIES). Of these, FS-3100, FS-34, and FS-300 (all manufactured by The Chemours Company), FT-110, FT-250, FT-251, FT-400S, FT-150, and FT-400SW (all manufactured by NEOS COMPANY LIMITED), POLYFOX PF-151N (manufactured by OMNOVA SOLUTIONS INC.), and UNIDYNE DSN-403N (manufactured by DAIKIN INDUSTRIES) are particularly preferable in terms of good printing quality, coloring in particular, and improvement on permeation, wettability, and uniform dyeing property to paper.

The proportion of the surfactant is not particularly limited and can be suitably selected to suit to a particular application. It is preferably from 0.001 to 5 percent by mass and more preferably from 0.05 to 5 percent by mass in terms of excellent wettability and discharging stability and improvement on image quality.

Defoaming Agent

The defoaming agent has no particular limit. For example, silicone-based defoaming agents, polyether-based defoaming agents, and aliphatic acid ester-based defoaming agents are suitable. These can be used alone or in combination. Of these, silicone-based defoaming agents are preferable to easily break foams.

Preservatives and Fungicides

The preservatives and fungicides are not particularly limited. A specific example is 1,2-benzisothiazolin-3-on.

Corrosion Inhibitor

The corrosion inhibitor has no particular limit. Examples thereof are acid sulfite and sodium thiosulfate.

pH Regulator

The processing fluid of the present disclosure may contain a pH regulator. The pH regulator is not particularly limited, and examples of the pH regulator include, but are not limited to, amines such as diethanol amine and triethanol amine. The pH of the processing fluid is preferably from 7 through 12 and more preferably from 8 through 11 in terms of preventing corrosion of any metallic member that may contact the processing fluid.

<<Print Medium>>

By application of the processing fluid of the present disclosure, a print medium having a Cobb water absorption, stipulated by JIS-P8140, of 20 g/m² or greater but 75 g/m² or less when contacted with water for 120 seconds can produce a printed matter excellent in dense color development and bleed resistance. Also when a print medium is cardboard (liner paper), the print medium can suitably produce a printed matter excellent in dense color development and bleed resistance.

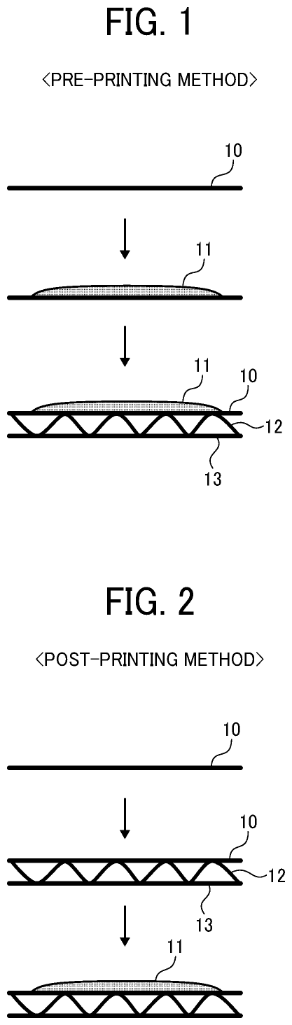

Here, the methods for cardboard printing are roughly classified into a method of recording an image 11 over cardboard base paper (front liner paper 10) with print inks and then pasting the base paper with a corrugating medium 12 and back liner paper 13 using a corrugator to produce a piece of cardboard (pre-printing method) as illustrated in FIG. 1, and a method of recording an image 11 over the front liner paper 10 of an already pasted piece of cardboard with print inks (post-printing method) as illustrated in FIG. 2. The present disclosure can be suitably used for both of these methods.

The pre-printing method is suitably used because front liner paper can be wound in a roll form, making it possible to use continuous paper as a print medium and to use a printer for continuous paper for printing. The post-printing method is suitably used because the print medium can be stored with ease, and after printing, the printed matter can be directly delivered to the customer.

Cardboard is basically formed of three pieces of paper, namely, front liner paper, a corrugating medium, and back liner paper. It is possible to adjust the strength of cardboard by changing the materials of the front liner paper, the corrugating medium, and the back liner paper. Corrugating media have different flute height standards. Basic standards are 5 mm and 3 mm. For example, a five-layered “double wall corrugated fiberboard” including corrugating media in a plurality of layers can also be used as a print medium in the present disclosure.

According to the present disclosure, it is possible to suitably print images over front liner paper both by the pre-printing method and by the post-printing method. Double-sided cardboard printing including printing over the back liner paper is also available.

Examples of the fiber material used for producing liner paper include, but are not limited to, bleached kraft pulp of hardwood or softwood, unbleached kraft pulp of hardwood or softwood, and sulfite pulp of hardwood or softwood. Moreover, for example, virgin pulp such as pulp, ground pulp, chemiground pulp, and semi-chemical pulp that are chemically treated with, for example, chemically treated pulp, kenaf, hemp, and reed, and used paper of, for example, cardboard, newspaper, magazines, and flyers can also be used.

The cardboard base paper (liner paper) has a Cobb water absorption, stipulated by JIS-P8140, of 20 g/m² or greater but 75 g/m² or less, preferably 23 g/m² or greater but 69 g/m² or less, and more preferably 35 g/m² or greater but 60 g/m² or less when contacted with water for 120 seconds. When the Cobb water absorption of the cardboard base paper is 20 g/m² or greater, a white ink can spread over the cardboard base paper suitably, and are not likely to be repelled on the surface. When the Cobb water absorption of the cardboard base paper is 75 g/m² or less, a white ink can fix on the cardboard base paper well, and can prevent occurrence of bleed.

The Cobb water absorption is a degree of Cobb water absorption for a water contact time of 120 seconds, as stipulated by JIS-P8140. For example, cardboard base paper (test piece) having a contact area of 100 cm² with water is set in a cylinder, water (100 mL) is poured into the cylinder in a state that the base paper and the cylinder are nipped with a clamp so that water may not leak, water is discarded after the contact time of 120 seconds, excessive water on the base paper is quickly removed with blotting paper, and the weight change of the base paper is weighed. In this way, the Cobb water absorption can be measured.

The paper weight of the cardboard base paper (liner paper) is preferably 100 g/m² or greater but 400 g/m² or less, and in terms of the aptitude for pasting by a corrugator, more preferably 150 g/m² or greater but 300 g/m² or less.

The brightness L* of the print medium is preferably 60 or lower and more preferably 55 or lower.

When the brightness L* of the print medium is 60 or less, there occurs a greater brightness difference between a white ink-printed region and a non-printed region. Therefore, a white ink advantageously has an improved visibility.

The brightness L* can be measured with, for example, a spectroscopic colorimetric densitometer (instrument name: X-RITE 939, available from X-Rite Inc.).

<White Ink Applying Step and White Ink Applying Unit>

The white ink applying step is a step of applying a white ink containing a white coloring material and water to form a white ink layer, and is performed by the white ink applying unit.

The method for applying a white ink is not particularly limited. Examples of the method include, but are not limited to, an inkjet method, a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a four-roll coating method, a five-roll coating method, a dip coating method, a curtain coating method, a slide coating method, and a die coating method. Among these methods, an inkjet method is suitably used.

In the white ink applying step, it is preferable to apply the white ink twice or more in terms of improving a hiding power.

In terms of improving a hiding power, the amount of the white ink to be applied when forming a solid image is preferably 5 g/m² or greater but 25 g/m² or less, more preferably 10 g/m² or greater but 25 g/m² or less, and yet more preferably 11 g/m² or greater but 22 g/m² or less.

<<White Ink>>

The white ink contains a white coloring material and water, and further contains other components as needed.

White Coloring Material

ISO-2469 (JIS-8148) is a standard for the degree of whiteness of a white ink. Typically, when the degree of whiteness of a material is 70 or greater, the material is used as a white coloring material.

Metal oxides are preferable as the coloring material used in the white ink. Examples of metal oxides include, but are not limited to, titanium oxide, iron oxide, tin oxide, zirconium oxide, and iron titanate (a complex oxide of iron and titanium). White particles having a hollow structure are also suitably used.

Examples of white particles having a hollow structure used in a white ink include, but are not limited to, hollow resin particles and hollow inorganic particles.

Examples of resin compositions of hollow resin particles include, but are not limited to, acrylic-based resins such as acrylic resins, styrene-acrylic resins, and cross-linked styrene-acrylic resins, urethane-based resins, and maleic-based resins.

Examples of materials of hollow inorganic particles include, but are not limited to, inorganic compounds such as oxides, nitrides, and nitride oxides of metals such as silicon, aluminum, titanium, strontium, and zirconium that have a white color, various kinds of glass, and silica. A metal oxide used as a coloring material in the white ink is excellent in terms of improving the degree of whiteness. White particles having a hollow structure used as a coloring material in the white ink tend not to settle, and are excellent in terms of a settling property.

The proportion of the white coloring material in the white ink is preferably from 0.1 to 15 percent by mass and more preferably from 1 to 10 percent by mass.

To obtain the ink, the pigment is dispersed by, for example, preparing a self-dispersible pigment by introducing a hydrophilic functional group into the pigment, coating the surface of the pigment with resin, or using a dispersant.

To prepare a self-dispersible pigment by introducing a hydrophilic functional group into a pigment, for example, it is possible to add a functional group such as sulfone group or carboxyl group to the pigment (e.g., carbon) to disperse the pigment in water.

To coat the surface of the pigment with resin, the pigment is encapsulated by microcapsules to make the pigment dispersible in water. This can be referred to as a resin-coated pigment. In this case, the pigment to be added to ink is not necessarily wholly coated with resin. Pigments partially or wholly uncovered with resin may be dispersed in the ink unless the pigments have an adverse impact.

To use a dispersant, for example, a known dispersant of a small molecular weight type or a high molecular weight type represented by a surfactant is used to disperse the pigments in ink. As the dispersant, it is possible to use, for example, anionic surfactants, cationic surfactants, nonionic surfactants, amphoteric surfactants, etc. depending on the pigments.

Also, a nonionic surfactant (RT-100, manufactured by TAKEMOTO OIL & FAT CO., LTD.) and a formalin condensate of naphthalene sodium sulfonate are suitable as dispersants.

These dispersants can be used alone or in combination.

Pigment Dispersion

The ink can be obtained by mixing a pigment with materials such as water and organic solvent. It is also possible to mix a pigment with water, a dispersant, etc., first to prepare a pigment dispersion and thereafter mix the pigment dispersion with materials such as water and organic solvent to manufacture ink.

The pigment dispersion is obtained by mixing and dispersing water, pigment, pigment dispersant, and other optional components and adjusting the particle size. It is good to use a dispersing device for dispersion.

The particle diameter of the pigment in the pigment dispersion has no particular limit. For example, the maximum frequency in the maximum number conversion is preferably from 20 to 500 nm and more preferably from 20 to 150 nm to improve dispersion stability of the pigment and ameliorate the discharging stability and image quality such as image density. The particle diameter of the pigment can be measured using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the proportion is preferably from 0.1 to 50 percent by mass and more preferably from 0.1 to 30 percent by mass.

During the production, coarse particles are optionally filtered off from the pigment dispersion with a filter, a centrifuge, etc. preferably followed by degassing.

Water

The water is not particularly limited and may be appropriately selected depending on the intended purpose. Examples of the water include, but are not limited to, pure water such as ion-exchanged water, ultrafiltrated water, reverse osmotic water, and distilled water, and ultrapure water. One of these kinds of water may be used alone or two or more of these kinds of water may be used in combination.

The proportion of water in the white ink has no particular limit and can be suitably selected to suit to a particular application. In terms of the drying property and discharging reliability of the ink, the proportion is preferably from 10 to 90 percent by mass and more preferably from 20 to 60 percent by mass.

Other Components

Examples of the other components include, but are not limited to, a resin, an organic solvent, a surfactant, a defoaming agent, a preservative and a fungicide, a corrosion inhibitor, and a pH regulator.

Resin

The type of the resin contained in the ink has no particular limit and can be suitably selected to suit to a particular application. Specific examples thereof include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Particles of such resins may be also used. It is possible to mix a resin emulsion in which the resin particles are dispersed in water serving as a dispersion medium with materials such as a coloring agent and an organic solvent to obtain ink. The resin particle can be synthesized or is available on the market. It is possible to synthesize the resin particle or obtain from market. These can be used alone or in combination of the resin particles.

The volume average particle diameter of the resin particle is not particularly limited and can be suitably selected to suit to a particular application. The volume average particle diameter is preferably from 10 to 1,000 nm, more preferably from 10 to 200 nm, and furthermore preferably from 10 to 100 nm to obtain good fixability and image hardness.

The volume average particle diameter can be measured by using a particle size analyzer (Nanotrac Wave-UT151, manufactured by MicrotracBEL Corp.).

The proportion of the resin is not particularly limited and can be suitably selected to suit to a particular application. In terms of fixability and storage stability of ink, it is preferably from 1 to 30 percent by mass and more preferably from 5 to 20 percent by mass to the total content of the ink.

The particle diameter of the solid portion in ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as image density. The solid portion includes resin particles, particles of pigments, etc. The particle diameter of the solid portion can be measured by using a particle size analyzer (Nanotrac Wave-UT151, manufactured by MicrotracBEL Corp).

The organic solvent, the surfactant, the defoaming agent, the preservative and the fungicide, the corrosion inhibitor, and the pH regulator are not particularly limited and may be appropriately selected depending on the intended purpose. For example, the same organic solvent, surfactant, defoaming agent, preservative and fungicide, corrosion inhibitor, and pH regulator as contained in the processing fluid can be used.

It is possible to prepare the white ink by dispersing or dissolving the components described above in, for example, water serving as a solvent, and further stirring and mixing the resultant as needed.

For the stirring and mixing, for example, a stirrer using an ordinary stirring blade, a magnetic stirrer, and a high-speed disperser can be used.

The property of the white ink is not particularly limited and can be suitably selected to suit to a particular application. For example, viscosity, surface tension, pH, etc., are preferably in the following ranges.

The viscosity of the white ink at 25 degrees C. is preferably from 5 to 30 mPa-s and more preferably from 5 to 25 mPa-s to improve print density and text quality and obtain good dischargeability. The viscosity can be measured by, for example, a rotatory viscometer (RE-80L, manufactured by TOKI SANGYO CO., LTD.). The measuring conditions are as follows:
Standard cone rotor (1° 34′×R24)
Sample liquid amount: 1.2 mL
Number of rotations: 50 rotations per minute (rpm)
25 degrees C.
Measuring time: three minutes

The surface tension of the white ink is preferably 35 mN/m or less and more preferably 32 mN/m or less at 25 degrees C. in terms that the ink is suitably levelized on a print medium and the drying time of the ink is shortened.

The pH of the white ink is preferably from 7 to 12 and more preferably from 8 to 11 in terms of prevention of corrosion of metal materials contacting the ink.

<Non-White Ink Applying Step and Non-White Ink Applying Unit>

The non-white ink applying step is a step of applying a non-white ink containing a non-white coloring material and water to the white ink layer after securing a time interval of 0.5 seconds or longer after the white ink is applied without providing a drying step of performing drying with a drying unit after the white ink is applied. The non-white ink applying step can be performed by the non-white ink applying unit.

The method for applying the non-white ink is not particularly limited. Examples of the method include, but are not limited to, an inkjet method, a blade coating method, a gravure coating method, a gravure offset coating method, a bar coating method, a roll coating method, a knife coating method, an air knife coating method, a comma coating method, a U-comma coating method, an AKKU coating method, a smoothing coating method, a microgravure coating method, a reverse roll coating method, a four-roll coating method, a five-roll coating method, a dip coating method, a curtain coating method, a slide coating method, and a die coating method. Among these methods, an inkjet method is preferable.

The amount of the non-white ink to be applied when forming a solid image is preferably 5 g/m² or greater but 15 g/m² or less and more preferably 7 g/m² or greater but 15 g/m² or less in terms of realizing a high image density.

Zero point five seconds or longer is needed as a time interval from after the white ink is applied until before the non-white ink is applied. The time interval is preferably 1 second or longer, more preferably 1 second or longer but 4 seconds or shorter, and yet more preferably 2 seconds or longer but 4 seconds or shorter.

When the time interval from after the white ink is applied until before the non-white ink is applied is 0.5 seconds or longer, it is possible to secure a time needed for the multivalent metal salt contained in the processing fluid to serve as a flocculant and react with the white coloring material contained in the white ink, and prevent bleed (color bleed) and density degradation due to mixed presence of the non-white ink and the white ink.

The “time interval from after the white ink is applied until before the non-white ink is applied” means a period of time from after the white ink is applied to (or lands on) a print medium until before the non-white ink is applied to (or lands on) the print medium. For example, it is possible to know the time interval by dividing the distance [m] between the position on which the white ink lands and the position on which the non-white ink lands in the printer by a conveying speed [m/sec] at which the print medium is conveyed, or by directly measuring the period of time from after the white ink lands until before the non-white ink lands with a measuring instrument such as a stop watch or a timer having a sensor.

<<Non-White Ink>>

The non-white ink contains a non-white coloring material and water, and further contains other components as needed.

Non-White Coloring Material

Examples of the non-white ink include, but are not limited to, color inks, black inks, gray inks, clear inks, and metallic inks.

Examples of the color inks include, but are not limited to, cyan inks, magenta inks, yellow inks, light cyan inks, light magenta inks, red inks, green inks, blue inks, orange inks, and violet inks.

The coloring material used in the non-white ink is not particularly limited and may be appropriately selected depending on the intended purpose so long as the coloring material has a non-white color. Examples of the coloring material include, but are not limited to, dyes and pigments. One of these coloring materials may be used alone or two or more of these coloring materials may be used in combination. Among these coloring materials, pigments are preferable.

Examples of the pigments include, but are not limited to, inorganic pigments and organic pigments.

Examples of the inorganic pigments include, but are not limited to, calcium carbonate, barium sulfate, aluminum hydroxide, barium yellow, cadmium red, and chromium yellow, and carbon black manufactured by known methods such as contact methods, furnace methods, and thermal methods. One of these inorganic pigments may be used alone or two or more of these inorganic pigments may be used in combination.

Examples of the organic pigments include, but are not limited to, azo-pigments (azo lake, insoluble azo pigments, condensed azo pigments, and chelate azo pigments), polycyclic pigments (phthalocyanine pigments, perylene pigments, perinone pigments, anthraquinone pigments, quinacridone pigments, dioxazine pigments, indigo pigments, thioindigo pigments, isoindolinone pigments, and quinophthalone pigments, etc.), dye chelates (basic dye type chelates, acid dye type chelates, etc.), nitro pigments, nitroso pigments, and aniline black. One of these organic pigments may be used alone or two or more of these organic pigments may be used in combination.

Among these organic pigments, any that has a good affinity with a solvent is suitable for use.

Specific examples of the pigments for black include, but are not limited to, carbon black (C.I. Pigment Black 7) such as furnace black, lamp black, acetylene black, and channel black, copper and iron (C.I. Pigment Black 11), and organic pigments such as aniline black (C.I. Pigment Black 1). One of these pigments may be used alone or two or more of these pigments may be used in combination.

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, and 155; C.I. Pigment Orange 5, 13, 16, 17, 36, 43, and 51; C.I. Pigment Red 1, 2, 3, 5, 17, 22, 23, 31, 38, 48:2 (Permanent Red 2B(Ca)), 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 185, 190, 193, 209, and 219; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3 (Phthalocyanine Blue), 16, 17:1, 56, 60, and 63; and C.I. Pigment Green 1, 4, 7, 8, 10, 17, 18, and 36. One of these pigments may be used alone or two or more of these pigments may be used in combination.

Specific examples of the dye include, but are not limited to, C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1, and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct Black 19, 38, 51, 71, 154, 168, 171, and 195; C.I. Reactive Red 14, 32, 55, 79, and 249; and C.I. Reactive Black 3, 4, and 35. One of these dyes may be used alone or two or more of these dyes may be used in combination.

Examples of coloring materials used in metallic inks include, but are not limited to, elemental metals, metal alloys, and particles obtained by minutely grinding metal compounds. Specific examples of coloring materials used in metallic inks include, but are not limited to, coloring materials formed of one or a plurality selected from the group of elemental metals consisting of aluminum, silver, gold, nickel, chromium, tin, zinc, indium, titanium, silicon, copper, and platinum, and metal alloys. Examples of the metal compounds include, but are not limited to, compounds formed of one or a plurality selected from the group consisting of oxides, nitrides, sulfides, and carbides of elemental metals or metal alloys.

The proportion of the non-white coloring material in the non-white ink is preferably from 0.1 to 15 percent by mass and more preferably from 1 to 10 percent by mass.

Water

The water is not particularly limited and may be appropriately selected depending on the intended purpose. The same water as contained in the white ink can be used.

Other Components

Examples of the other components include, but are not limited to, a resin, an organic solvent, a surfactant, a defoaming agent, a preservative and a fungicide, a corrosion inhibitor, and a pH regulator.

The resin is not particularly limited and may be appropriately selected depending on the intended purpose. The same resin as contained in the white ink can be used.

The organic solvent, the surfactant, the defoaming agent, the preservative and the fungicide, the corrosion inhibitor, and the pH regulator are not particularly limited and may be appropriately selected depending on the intended purpose, and are the same as the components contained in the processing fluid. Therefore, descriptions about these components are skipped.

<Drying Step and Drying Unit>

In the present disclosure, after a pre-processing fluid is applied to a print medium, the print medium to which the pre-processing fluid is applied is dried. Next, a white ink is applied. After the white ink is applied, a drying step of performing drying with a drying unit is not provided, but a non-white ink is applied after a time interval of 0.5 seconds or longer is secured after the white ink is applied. After the non-white ink is applied, the print medium to which the white ink and the non-white ink are applied is dried. Alternatively, after a pre-processing fluid is applied to a print medium, a white ink is applied next without drying the print medium to which the pre-processing fluid is applied. After the white ink is applied, a drying step of performing drying with a drying unit is not provided, but a non-white ink is applied after a time interval of 0.5 seconds or longer is secured after the white ink is applied. After the non-white ink is applied, the print medium to which the white ink and the non-white ink are applied is dried.

After the white ink is applied, a non-white ink is applied without providing a drying step of performing drying with a drying unit. The drying unit meant here is, for example, a roll heater, a drum heater, a hot air dryer, an infrared dryer, and an ultraviolet dryer, i.e., a drying unit other than natural drying. It is only needed not to provide a drying step using a drying unit from after the white ink is applied until before the non-white ink is applied. Therefore, natural drying is not excluded.

After the white ink is applied, a non-white ink is applied after a time interval of 0.5 seconds or longer is secured, without providing a drying step of performing drying with a drying unit. Here, it is preferable to secure the time interval of 0.5 seconds or longer at 0 degrees C. or higher but 50 degrees C. or lower. It is more preferable to secure the time interval of 0.5 seconds or longer at 15 degrees C. or higher but 40 degrees C. or lower.

After the white ink is applied, a time interval of 0.5 seconds or longer is secured until before the non-white ink is applied. The time interval is preferably 1 second or longer, more preferably 1 second or longer but 4 seconds or shorter, and yet more preferably 2 seconds or longer but 4 seconds or shorter.

The drying step of drying the print medium to which the non-white ink is applied is performed by a drying unit.

Drying the print medium to which the non-white ink is applied is a step of heating and drying the print medium (cardboard base paper) by a known method such as a roll heater, a drum heater, a hot air dryer, an infrared dryer, and an ultraviolet dryer. It is preferable to put the print medium under a condition at which the surface temperature of the print medium becomes 60 degrees C. or higher, and preferably 60 degrees C. or higher but 100 degrees C. or lower. The drying time is preferably 1 second or longer but shorter than 300 seconds.

(Printed Matter)

A printed matter of the present disclosure includes: a print medium; a processing fluid layer on the print medium, where the processing fluid layer contains a multivalent metal salt; a white ink layer on the processing fluid layer, where the white ink layer contains a white coloring material; and a non-white ink layer on the white ink layer, where the non-white ink layer contains a non-white coloring material. The print medium has a Cobb water absorption of 20 g/m² or greater but 75 g/m² or less when contacted with water for 120 seconds, where the Cobb water absorption is stipulated by JIS-P8140.

Cardboard base paper can be suitably used as the print medium.

The printed matter includes an image that is formed over the print medium with the non-white ink used in the present disclosure.

The printing apparatus and the printing method of the present disclosure can be used to print an image over the print medium and produce a printed matter.

The printing apparatus needs not be a dedicated apparatus for cardboard printing. Therefore, an inkjet printing apparatus can be used.

<Printing Apparatus and Printing Method>

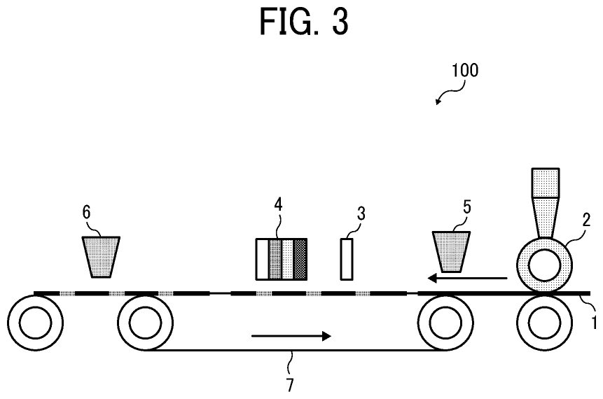

FIG. 3 is a schematic view illustrating an example of the printing apparatus used in the printing method of the present disclosure. The printing apparatus 100 of FIG. 3 includes a processing fluid applying device 2 configured to apply a processing fluid, a white ink discharging head 3 configured to discharge a white ink (W), non-white ink (color ink) discharging heads 4 configured to discharge a black ink (K), a cyan ink (C), a magenta ink (M), and a yellow ink (Y), a first drying device 5, a second drying device 6, and a conveyor belt 7 configured to convey a print medium 1.

In the printing apparatus of FIG. 3, the first drying device 5 is installed as needed between the processing fluid applying device 2 and the white ink discharging head 3. Even when the first drying device 5 is installed, it is not indispensable to dry a processing fluid applied. The second drying device 6 is installed backward from the yellow ink (Y) discharging head among the non-white ink (color ink) discharging heads 4. It is preferable to dry the non-white inks in terms of preventing scratching and backside staining of the non-white inks.

As described above, after the white ink is applied to a print medium, the non-white inks are applied after a time interval of 0.5 seconds or longer is secured without providing a drying step of performing drying with a drying unit. Therefore, there is a need for providing an appropriate distance between the white ink discharging head 3 and the color ink discharging heads 4 in FIG. 3. For example, when performing printing at a speed of 60 meters per minute, in order to secure a time interval of 0.5 seconds or longer, it is preferable to separate the white ink discharging head 3 and the color ink discharging heads 4 from each other by about 0.5 meters or greater. Likewise, in order to secure a time interval of 2 seconds or longer, it is preferable to separate the white ink discharging head 3 and the color ink discharging heads 4 from each other by about 2.0 meters or greater. It is optional to integrate the white ink discharging head 3 with the color ink discharging heads 4 as one discharging head, and move the integrated discharging head to a desired discharging position.

In FIG. 3, it is optional to arrange two or more white ink discharging heads 3 continuously and overlay two or more layers of the white ink. In this case, a better white ink hiding power can be obtained.

The printing apparatus and the printing method may further optionally include a heater for use in the heating process and a drier for use in the drying process. For example, the heating device and the drying device heat and dry the top surface and the bottom surface of a print medium having an image. The heating device and the drying device are not particularly limited. For example, a fan heater and an infra-red heater can be used. The print medium can be heated and dried before, during, and after printing.

In addition, the printing apparatus and the printing method are not limited to those producing merely meaningful visible images such as texts and figures with the ink. For example, the printing apparatus and the printing method can produce patterns like geometric design and 3D images.

In addition, the printing apparatus includes both a serial type apparatus in which the liquid discharging head is caused to move and a line type apparatus in which the liquid discharging head is not moved, unless otherwise specified.

Furthermore, in addition to the desktop type, this printing apparatus includes a wide type capable of printing images on a large print medium such as A0, and a continuous printer capable of using continuous paper wound up in a roll form as print media.

Moreover, image forming, recording, printing, etc. in the present disclosure represent the same meaning.

Recording media, media, and print media represent the same meaning.

### EXAMPLES

The present disclosure will be described below by way of Examples. The present disclosure should not be construed as being limited to these Examples. Unless otherwise particularly specified, for example, preparations and evaluations in Examples and Comparative Examples were performed at 25 degrees C. at a relative humidity of 60%.

### White Pigment Dispersion Preparation Example 1

Preparation of White Pigment Dispersion 1

After the mixture of the prescription described below was pre-mixed, the resultant was subjected to circulation dispersion treatment for 7 hours with a disk-type bead mill (obtained from Shinmaru Enterprises Corporation, KDL type, using zirconia balls having a diameter of 0.3 mm as media), to obtain a white pigment dispersion 1 (with a pigment concentration of 40% by mass).

<Prescription of White Pigment Dispersion 1>
C.I. Pigment White 7 (obtained from Ishihara Sangyo Kaisha, Ltd.): 40 parts by mass
Acrylic-based polymeric dispersant (DISPERBYK-2015, obtained from BYK Japan K.K.): 5 parts by mass
Ion-exchanged water: 55 parts by mass

### Non-White Pigment Dispersion Preparation Example 1

Preparation of Magenta Pigment Dispersion 1

After the mixture of the prescription described below was pre-mixed, the resultant was subjected to circulation dispersion treatment for 7 hours with a disk-type bead mill (obtained from Shinmaru Enterprises Corporation, KDL type, using zirconia balls having a diameter of 0.3 mm as media), to obtain a magenta pigment dispersion 1 (with a pigment concentration of 15% by mass).

<Prescription of Magenta Pigment Dispersion 1>
C.I. Pigment Red 269 (obtained from Clariant Japan K.K.): 15 parts by mass
Acrylic-based polymeric dispersant (DISPERBYK-2010, obtained from BYK Japan K.K.): 5 parts by mass
Ion-exchanged water: 80 parts by mass

### White Ink Production Example 1

Production of White Ink 1

After the mixture of the Prescription of white ink 1 described below was pre-mixed, the resultant was stirred with a dissolver (DISPERMAT LC30, obtained from Eko Instruments Co., Ltd.) at 2,000 rpm for 10 minutes and subsequently filtrated through a polypropylene filter having an average pore diameter of 0.8 micrometers, to obtain a white ink 1.

<Prescription of White Ink 1>
White pigment dispersion 1 described above: 30 parts by mass
TEGO (registered trademark) WET 270 (a silicone-based surfactant, obtained from Evonik Industries AG):1 part by mass
PROXEL LV (a preservative and a fungicide, obtained from Avecia Inc.): 0.1 parts by mass
1,2-Propanediol: 25 parts by mass
Propylene glycol monomethyl ether acetate: 5 parts by mass
Ion-exchanged water: 38.9 parts by mass

### Non-White Ink Production Example 1

Production of Magenta Ink 1

After the mixture of the Prescription of magenta ink 1 described below was pre-mixed, the resultant was stirred with a dissolver (DISPERMAT LC30, obtained from Eko Instruments Co., Ltd.) at 2,000 rpm for 10 minutes and subsequently filtrated through a polypropylene filter having an average pore diameter of 0.8 micrometers, to obtain a magenta ink 1.

<Prescription of Magenta Ink 1>
Magenta pigment dispersion 1 described above: 30 parts by mass
TEGO (registered trademark) WET 270 (a silicone-based surfactant, obtained from Evonik Industries AG):1 part by mass
PROXEL LV (a preservative and a fungicide, obtained from Avecia Inc.): 0.1 parts by mass
1,2-Propanediol: 25 parts by mass
Propylene glycol monomethyl ether acetate: 5 parts by mass
Ion-exchanged water: 38.9 parts by mass

### Processing Fluid Preparation Example 1

Preparation of Processing Fluid 1

After the mixture of the Prescription of processing fluid 1 described below was pre-mixed, the resultant was stirred with a dissolver (DISPERMAT LC30, obtained from Eko Instruments Co., Ltd.) at 2,000 rpm for 10 minutes, to obtain a processing fluid 1. The viscosity of the processing fluid 1 at 25 degrees C. was 7.0 mPa·s.

<Prescription of Processing Fluid 1>
1,2-Propanediol: 10.0 parts by mass
3-Methoxybutanol: 10.0 parts by mass
TEGO (registered trademark) WET270 (a silicone-based surfactant, obtained from Evonik Industries AG): 0.5 parts by mass
PROXEL LV (obtained from Avecia Inc., a preservative and a fungicide): 0.1 parts by mass
Magnesium acetate tetrahydrate: 12.0 parts by mass
Ion-exchanged water: 67.4 parts by mass

### Processing Fluid Preparation Example 2

Preparation of Processing Fluid 2

After the mixture of the Prescription of processing fluid 2 described below was pre-mixed, the resultant was stirred with a dissolver (DISPERMAT LC30, obtained from Eko Instruments Co., Ltd.) at 2,000 rpm for 10 minutes, to obtain a processing fluid 2. The viscosity of the processing fluid 2 at 25 degrees C. was 6.8 mPa-s.

<Prescription of Processing Fluid 2>
1,2-Propanediol: 10.0 parts by mass
3-Methoxybutanol: 10.0 parts by mass
TEGO (registered trademark) WET270 (a silicone-based surfactant, obtained from Evonik Industries AG): 0.5 parts by mass
PROXEL LV (obtained from Avecia Inc., a preservative and a fungicide): 0.1 parts by mass
Magnesium acetate tetrahydrate: 6.0 parts by mass
Ion-exchanged water: 73.4 parts by mass

### Examples 1 to 10 and Comparative Examples 1 to 5

<Processing Fluid Applying Step>

NPK LINER TF (with a paper weight of 170 g/m², brown cardboard base paper, with a Cobb water absorption of 55 g/m² and brightness L* of 51, obtained from Nippon Paper Industries Co., Ltd.) was used as a print medium. The processing fluid 1 or the processing fluid 2 was applied to the print medium with a bar coater. The Cobb water absorption was a value measured for a water contact time of 120 seconds as stipulated by JIS-P8140. The amount of the processing fluid applied was 10 g/m².

After the processing fluid was applied, under a condition that the processing fluid should be dried, the processing fluid was dried in a dryer set to 80 degrees C. for 2 minutes. On the other hand, under a condition that the processing fluid should not be dried, a white ink was printed five minutes after the processing fluid was applied.

<White Ink Applying Step>

With an inkjet discharging head (obtained from Ricoh Company, Ltd., MH5421MF) filled with the white ink 1, a solid image having a width of 5 cm and a length of 20 cm was formed at 600 dpi over the print medium to which the processing fluid was applied. The print medium was put on a conveyor device, and passed right below the inkjet discharging head at a speed of 48 meters/minute, to print the white ink 1. The amount of the white ink 1 applied was 11 g/m².

When printing the white ink 1 twice continuously, two such inkjet discharging heads as described above were coupled with each other to print the white ink. In this case, the amount of the white ink 1 applied was 22 g/m².

After printing, under a condition that the white ink 1 should be dried, the white ink 1 was dried in a dryer set to 80 degrees C. for 2 minutes. Under a condition that the white ink 1 should not be dried, the magenta ink 1 was printed continuously after the numbers of seconds described in Table 1 to Table 3 passed after the white ink 1 was printed.

<Non-White Ink Applying Step>

With an inkjet discharging head (obtained from Ricoh Company, Ltd., MH5421MF) filled with the magenta ink 1, a solid image having a width of 4 cm and a length of 10 cm was formed at 600 dpi right above the white ink 1 printed over the print medium. The inkjet discharging head filled with the magenta ink 1 was installed backward from the inkjet discharging head filled with the white ink 1 above the conveyor device at a distance at which the period of time that would pass from after the white ink 1 was printed until before the magenta ink 1 would be printed continuously would be the numbers of seconds described in Table 1 to Table 3. In Example 1, the interval between the inkjet discharging head filled with the white ink 1 and the inkjet discharging head filled with the magenta ink 1 was 1.6 meters.

<Print Medium Drying Step>

After the magenta ink 1 was printed, the print medium was dried in a dryer set to 80 degrees C. for 2 minutes.

Next, “white ink hiding power”, “bleed of magenta ink over white ink”, “magenta ink density over white ink”, and “cissing of magenta ink over white ink” were evaluated in the manners described below. The results are presented in Table 1 to Table 3.

<Evaluation of White Ink Hiding Power>

Ten sheets of RECOPY PPC PAPER TYPE 6200 (obtained from Ricoh Company, Ltd.) were laid below the print medium of each combination presented in Table 1 to Table 3 as the background for colorimetry, and brightness (L* value) was measured at arbitrary five positions in the solid image formed only of the white ink. The average of the measurements was evaluated according to the criteria described below. B and A are practically usable levels.

<Evaluation Criteria>

A: Brightness (L* value) was 80 or higher.

B: Brightness (L* value) was 75 or higher but lower than 80.

C: Brightness (L* value) was 70 or higher but lower than 75.

D: Brightness (L* value) was lower than 70.

<Evaluation of Bleed of Magenta Ink Over White Ink>

An end portion of the magenta ink solid image formed over the white ink was visually observed, to measure an exuding distance by which the magenta ink solid image portion exuded to the white ink solid image of the print medium of each combination described in Table 1 to Table 3 and evaluate the exuding distance according to the criteria described below. C, B, and A are practically usable levels.

<Evaluation Criteria>

A: Almost no bleed was observed.

B: Bleed of an exuding distance of less than 0.5 mm was observed.

C: Bleed of an exuding distance of 0.5 mm or greater but less than 1 mm was observed.

D: Bleed of an exuding distance of 1 mm or greater was observed.

<Evaluation of Magenta Ink Density Over White Ink>

Ten sheets of RECOPY PPC PAPER TYPE 6200 (obtained from Ricoh Company, Ltd.) were laid below the print medium of each combination presented in Table 1 to Table 3 as the background for colorimetry, and the optical density (magenta) was measured at arbitrary five positions in the solid image formed of the magenta ink printed over the white ink. The average of the measurements was evaluated according to the criteria described below. C and B are practically usable levels.

<Evaluation Criteria>

B: The optical density (magenta) was 1.5 or higher.

C: The optical density (magenta) was 1.2 or higher but lower than 1.5.

D: The optical density (magenta) was lower than 1.2.

<Evaluation of Cissing of Magenta Ink Over White Ink>

The magenta ink solid image formed over the white ink was visually observed, to evaluate the degree of cissing of the magenta ink solid image portion over the white ink solid image of the print medium of each combination presented in Table 1 to Table 3 according to the criteria described below. B and A are practically usable levels.

<Evaluation Criteria>

A: No cissing of the magenta ink was observed, and there was no unevenness.

B: No cissing of the magenta ink was observed, but unevenness was observed.

C: The white ink underlying below the magenta ink was slightly exposed.

D: The white ink underlying below the magenta ink was obviously exposed.

TABLE 1

| | | Ex. | | | | |
|---|---|---|---|---|---|---|
| | | 1 | 2 | 3 | 4 | 5 |
| Processing | Processing fluid No. used | Processing | Processing | Processing | Processing | Processing |
| fluid | | fluid 1 | fluid 1 | fluid 1 | fluid 1 | fluid 1 |
| applying | | | | | | |
| step | | | | | | |
| Processing fluid drying step | | Present | Absent | Absent | Present | Present |
| White ink | White ink No. used | White | White | White | White | White |
| applying | | ink 1 | ink 1 | ink 1 | ink 1 | ink 1 |
| step | Number of times white ink was | 1 | 1 | 2 | 1 | 1 |
| | applied | | | | | |
| White ink drying step | | Absent | Absent | Absent | Absent | Absent |
| Non-white | Non-white ink No. used | Magenta | Magenta | Magenta | Magenta | Magenta |
| ink applying | | ink 1 | ink 1 | ink 1 | ink 1 | ink 1 |
| step | | | | | | |
| Time [sec] from after application of white ink until | | 2.0 | 2.0 | 2.0 | 4.0 | 1.0 |
| before application of non-white ink | | | | | | |
| Surface temperature (° C.) of print medium from after | | 25 | 25 | 25 | 25 | 25 |
| application of white ink until before step of applying | | | | | | |
| non-white ink | | | | | | |
| Non-white ink drying step | | Present | Present | Present | Present | Present |
| Evaluation | White ink hiding power | B | B | A | B | B |
| result | Bleed of magenta ink over white ink | B | A | B | A | B |
| | Magenta ink density over white ink | B | B | B | B | C |
| | Cissing of magenta ink over white ink | B | A | B | B | B |

TABLE 2

| | | Ex. | | | | |
|---|---|---|---|---|---|---|
| | | 6 | 7 | 8 | 9 | 10 |
| Processing | Processing fluid No. used | Processing | Processing | Processing | Processing | Processing |
| fluid | | fluid 1 | fluid 2 | fluid 1 | fluid 1 | fluid 1 |
| applying | | | | | | |
| step | | | | | | |
| Processing fluid drying step | | Present | Present | Present | Present | Present |
| White ink | White ink No. used | White | White | White | White | White |
| applying | | ink 1 | ink 1 | ink 1 | ink 1 | ink 1 |
| step | Number of times white ink was | 1 | 1 | 1 | 1 | 1 |
| | applied | | | | | |
| White ink drying step | | Absent | Absent | Absent | Absent | Absent |
| Non-white | Non-white ink No. used | Magenta | Magenta | Magenta | Magenta | Magenta |
| ink applying | | ink 1 | ink 1 | ink 1 | ink 1 | ink 1 |
| step | | | | | | |
| Time [sec] from after application of white ink until | | 0.5 | 2.0 | 2.0 | 2.0 | 2.0 |
| before application of non-white ink | | | | | | |
| Surface temperature (° C.) of print medium from after | | 25 | 25 | 15 | 40 | 7 |
| application of white ink until before step of applying | | | | | | |
| non-white ink | | | | | | |
| Non-white ink drying step | | Present | Present | Present | Present | Present |
| Evaluation | White ink hiding power | B | B | B | B | B |
| result | Bleed of magenta ink over white ink | C | C | C | C | C |
| | Magenta ink density over white ink | C | B | B | B | C |
| | Cissing of magenta ink over white ink | B | B | B | C | B |

TABLE 3

| | | Comp. Ex. | | | | |
|---|---|---|---|---|---|---|
| | | 1 | 2 | 3 | 4 | 5 |
| Processing | Processing fluid No. used | Processing | Processing | Processing | Processing | Processing |
| fluid | | fluid 1 | fluid 1 | fluid 1 | fluid 1 | fluid 1 |
| applying | | | | | | |
| step | | | | | | |
| Processing fluid drying step | | Present | Absent | Present | Present | Absent |
| White ink | White ink No. used | White | White | White | White | White |
| applying | | ink 1 | ink 1 | ink 1 | ink 1 | ink 1 |
| step | Number of times white ink was | 1 | 1 | 2 | 1 | 1 |
| | applied | | | | | |
| White ink drying step | | Present | Present | Present | Absent | Absent |
| Non-white | Non-white ink No. used | Magenta | Magenta | Magenta | Magenta | Magenta |
| ink applying | | ink 1 | ink 1 | ink 1 | ink 1 | ink 1 |
| step | | | | | | |
| Time [sec] from after application of white ink until | | White ink | White ink | White ink | 0.3 | 0.3 |
| before application of non-white ink | | layer was | layer was | layer was | | |
| | | dried | dried | dried | | |
| Surface temperature (° C.) of print medium from after | | 45 | 45 | 45 | 25 | 25 |
| application of white ink until before step of applying | | | | | | |
| non-white ink | | | | | | |
| Non-white ink drying step | | Present | Present | Present | Present | Present |
| Evaluation | White ink hiding power | B | B | A | B | B |
| result | Bleed of magenta ink over white ink | D | D | D | D | D |
| | Magenta ink density over white ink | D | D | D | D | C |
| | Cissing of magenta ink over white ink | D | D | D | B | B |

From the results of Table 1 to Table 3, Examples 1 to 10 were found to be better than Comparative Examples 1 to 5 in “white ink hiding power”, “bleed of magenta ink over white ink”, “magenta ink density over white ink”, and “cissing of magenta ink over white ink”. As compared, “bleed of magenta ink over white ink” and “cissing of magenta ink over white ink” occurred in Comparative Examples 1 to 3, in which the white ink layer was dried. This is considered due to reduction of mobility of any unreacted multivalent metal salt diffused in the white ink due to drying of the white ink and reduction of reactivity thereof with the coloring material (pigment) contained in the magenta ink. The degradation of “magenta ink density over white ink” is considered due to reduction of an ink receiving property of the magenta ink layer due to cissing.

In Comparative Examples 4 and 5, the time interval from after the white ink was applied until before the magenta ink was printed continuously were shorter than 0.5 seconds, and “bleed of magenta ink over white ink” occurred.

In Comparative Example 4, degradation of “magenta ink density over white ink” occurred. This is considered due to mixed presence (color bleed) of the magenta ink and the white ink due to insufficiency of the time needed for the multivalent metal salt contained in the processing fluid to serve as a flocculant and react with the coloring material (pigment) contained in the white ink.

Aspects of the present disclosure are, for example, as follows.

<1> A printing method including:
applying a processing fluid containing a multivalent metal salt to a print medium, to form a processing fluid layer;
applying a white ink containing a white coloring material and water to form a white ink layer; and
applying a non-white ink containing a non-white coloring material and water to the white ink layer after securing a time interval of 0.5 seconds or longer after the white ink is applied without performing drying with a drying unit after the white ink is applied, wherein the print medium has a Cobb water absorption of 20 g/m² or greater but 75 g/m² or less when contacted with water for 120 seconds, where the Cobb water absorption is stipulated by JIS-P8140.

<2> The printing method according to <1>,
wherein the securing a time interval of 0.5 seconds or longer without performing drying with a drying unit includes securing a time interval of 0.5 seconds or longer at 15 degrees C. or higher but 40 degrees C. or lower.

<3> The printing method according to <1> or <2>,
wherein the securing a time interval of 0.5 seconds or longer without performing drying with a drying unit includes securing a time interval of 1 second or longer but 4 seconds or shorter at 15 degrees C. or higher but 40 degrees C. or lower.

<4> The printing method according to any one of <1> to <3>,
wherein the print medium is cardboard base paper.

<5> The printing method according to any one of <1> to <4>,
wherein the print medium has a brightness L* of 60 or lower.

<6> The printing method according to any one of <1> to <5>,
wherein after the processing fluid is applied, the white ink is applied to the processing fluid layer without performing drying with a drying unit.

<7> The printing method according to any one of <1> to <6>,
wherein a proportion of the multivalent metal salt in the processing fluid is 7% by mass or greater.

<8> The printing method according to any one of <1> to <7>,
wherein after the white ink is applied, the non-white ink is applied to the white ink layer after a time interval of 2 seconds or longer but 4 seconds or lower is secured without performing drying of the white ink layer.

<9> The printing method according to any one of <1> to <8>,
wherein in the applying a white ink, the white ink is applied twice or more.

<10> The printing method according to any one of <1> to <9>, further including
drying the print medium to which the non-white ink is applied.

<11> The printing method according to any one of <1> to <10>,
wherein in the applying a white ink and the applying a non-white ink, the white ink and the non-white ink are applied by an inkjet method.

<12> A printing apparatus including:
a processing fluid applying unit configured to apply a processing fluid containing a multivalent metal salt to a print medium;
a white ink applying unit configured to apply a white ink containing a white coloring material and water to form a white ink layer; and
a non-white ink applying unit configured to apply a non-white ink containing a non-white coloring material and water to the white ink layer after securing a time interval of 0.5 seconds or longer after the white ink is applied without performing drying with a drying unit after the white ink is applied,
wherein the print medium has a Cobb water absorption of 20 g/m² or greater but 75 g/m² or less when contacted with water for 120 seconds, where the Cobb water absorption is stipulated by JIS-P8140.

<13> The printing apparatus according to <12>, further including
a drying unit configured to dry the print medium to which the non-white ink is applied.

<14> A printed matter including:
a print medium;
a processing fluid layer on the print medium, where the processing fluid layer contains a multivalent metal salt;
a white ink layer on the processing fluid layer, where the white ink layer contains a white coloring material; and
a non-white ink layer on the white ink layer, where the non-white ink layer contains a non-white coloring material,
wherein the print medium has a Cobb water absorption of 20 g/m² or greater but 75 g/m² or less when contacted with water for 120 seconds, where the Cobb water absorption is stipulated by JIS-P8140.

The printing method according to any one of <1> to <11>, the printing apparatus according to <12> or <13>, and the printed matter according to <14> can solve the various problems in the related art and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2020-155061, filed on Sep. 16, 2020 and Japanese Patent Application No. 2021-099313, filed on Jun. 15, 2021, in the Japan Patent Office, the entire disclosure of which is hereby incorporated by reference herein.

### REFERENCE SIGNS LIST

1: print medium
2: processing fluid applying device
3: white ink discharging head
4: non-white ink (color ink) discharging head
5: first drying device
6: second drying device
7: conveyor belt
100: printing apparatus

1. A printing method, comprising:
applying a processing fluid containing a multivalent metal salt to a print medium, to form a processing fluid layer:
applying a white ink containing a white coloring material and water, to form a white ink layer; and
applying a non-white ink containing a non-white coloring material and water to the white ink layer, after securing a time interval of 0.5 seconds or longer after the white ink is applied without performing drying with a drying unit after the white ink is applied,
wherein the print medium has a Cobb water absorption of 20 g/m² or greater but 75 g/m² or less when contacted with water for 120 seconds, where the Cobb water absorption is stipulated by JIS-P8140.

2. The printing method according to claim 1, wherein the securing a time interval of 0.5 seconds or longer without performing drying with a drying unit comprises securing a time interval of 0.5 seconds or longer at 15 degrees C. or higher but 40 degrees C. or lower.

3. The printing method according to claim 1, wherein the securing a time interval of 0.5 seconds or longer without performing drying with a drying unit comprises securing a time interval of 1 second or longer but 4 seconds or shorter at 15 degrees C. or higher but 40 degrees C. or lower.

4. The printing method according to claim 1, wherein the print medium is cardboard base paper.

5. The printing method according to claim 1, wherein the print medium has a brightness L* of 60 or lower.

6. The printing method according to claim 1, wherein after the processing fluid is applied, the white ink is applied to the processing fluid layer without performing drying with a drying unit.

7. The printing method according to claim 1, wherein a proportion of the multivalent metal salt in the processing fluid is 7% by mass or greater.

8. The printing method according to claim 1, wherein after the white ink is applied, the non-white ink is applied to the white ink layer after a time interval of 2 seconds or longer but 4 seconds or lower is secured without performing drying of the white ink layer.

9. The printing method according to claim 1, wherein in the applying a white ink, the white ink is applied twice or more.

10. The printing method according to claim 1, further comprising;
drying the print medium to which the non-white ink is applied.

11. The printing method according to claim 1, wherein in the applying a white ink and the applying a non-white ink, the white ink and the non-white ink are applied by an inkjet method.

12. A printing apparatus, comprising:
a processing fluid applying unit configured to apply a processing fluid containing a multivalent metal salt to a print medium;
a white ink applying unit configured to apply a white ink containing a white coloring material and water to form a white ink layer; and
a non-white ink applying unit configured to apply a non-white ink containing a non-white coloring material and water to the white ink layer after securing a time interval of 0.5 seconds or longer after the white ink is applied without performing drying with a drying unit after the white ink is applied,
wherein the print medium has a Cobb water absorption of 20 g/m² or greater but 75 g/m² or less when contacted with water for 120 seconds, where the Cobb water absorption is stipulated by JIS-P8140.

13. The printing apparatus according to claim 12, further comprising;
a drying unit configured to dry the print medium to which the non-white ink is applied.

14. A printed matter, comprising:
a print medium;
a processing fluid layer on the print medium, where the processing fluid layer contains a multivalent metal salt;
a white ink layer on the processing fluid layer, where the white ink layer contains a white coloring material; and
a non-white ink layer on the white ink layer, where the non-white ink layer contains a non-white coloring material,
wherein the print medium has a Cobb water absorption of 20 g/m² or greater but 75 g/m² or less when contacted with water for 120 seconds, where the Cobb water absorption is stipulated by JIS-P8140.
